(19) United States
(12) Patent Application Publication
(10) Pub. No.: US 2014/0307339 A1
(43) Pub. Date: Oct. 16, 2014

(54) LENS ELEMENT FACILITATING OPTICAL INSPECTION

(71) Applicant: HON HAI PRECISION INDUSTRY CO., LTD., New Taipei (TW)

(72) Inventor: CHEN-YU YU, New Taipei (TW)

(21) Appl. No.: 13/941,531

(22) Filed: Jul. 14, 2013

(30) Foreign Application Priority Data
Apr. 16, 2013 (TW) 102113380

(51) Int. Cl. G02B 3/00

(52) U.S. Cl. CPC G02B 3/0075
USPC 359/811

(57) ABSTRACT

A lens element includes a number of lenses and a mark. The lenses are substantially identical with each other in shape and size. The mark is different from the lenses in shape and size. The lenses and the mark are linearly arranged, with the mark located at an end of the lenses.

### BACKGROUND

1. Technical Field

The present disclosure relates to optical connectors, and particularly to a lens element for use in an optical connector to facilitate optical inspection.

2. Description of Related Art

Optical connectors include a number of photoelectric elements, a lens element, and a number of optical fibers. The lens element packages the photoelectric elements and forms a number of lenses to optically couple the photoelectric elements with the optical fibers that are arranged at a side of the lens element. To ensure high quality, the lenses are optically inspected to detect defects or contaminations. However, as the lenses are substantially identical in shape and size and are linearly arranged, it is difficult to recognize which lenses have been detected and which haven't.

Therefore, it is desirable to provide a lens element that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of a lens element, according to an embodiment.

FIG. 2 is a bottom view of the lens element of FIG. 1.

FIG. 3 is a side view of the lens element of FIG. 1.

FIG. 4 is a bottom view of a lens element, according to another embodiment.

FIG. 5 is a side view of the lens element of FIG. 4.

### DETAILED DESCRIPTION

Embodiments of the present disclosure will be described with reference to the drawings.

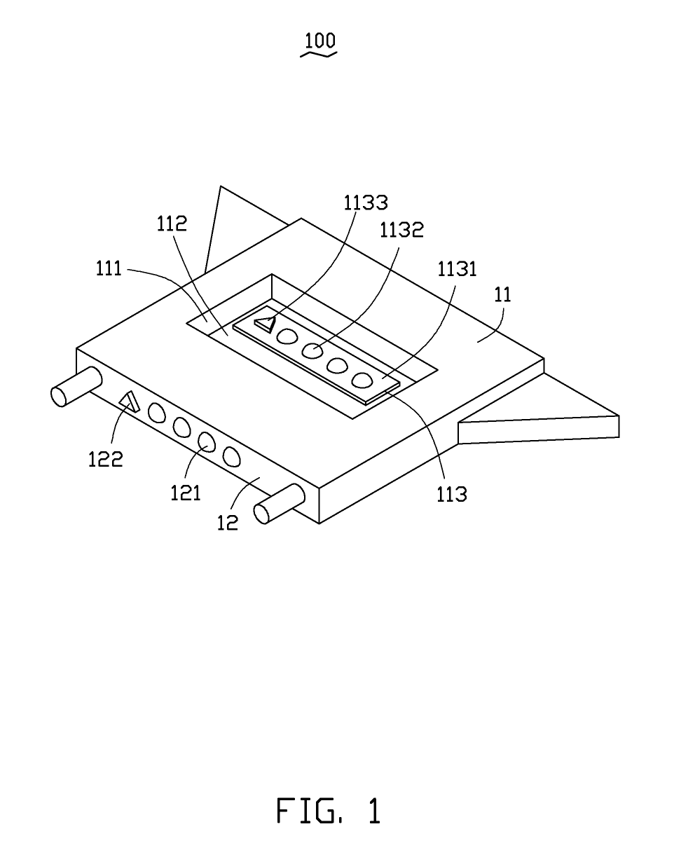

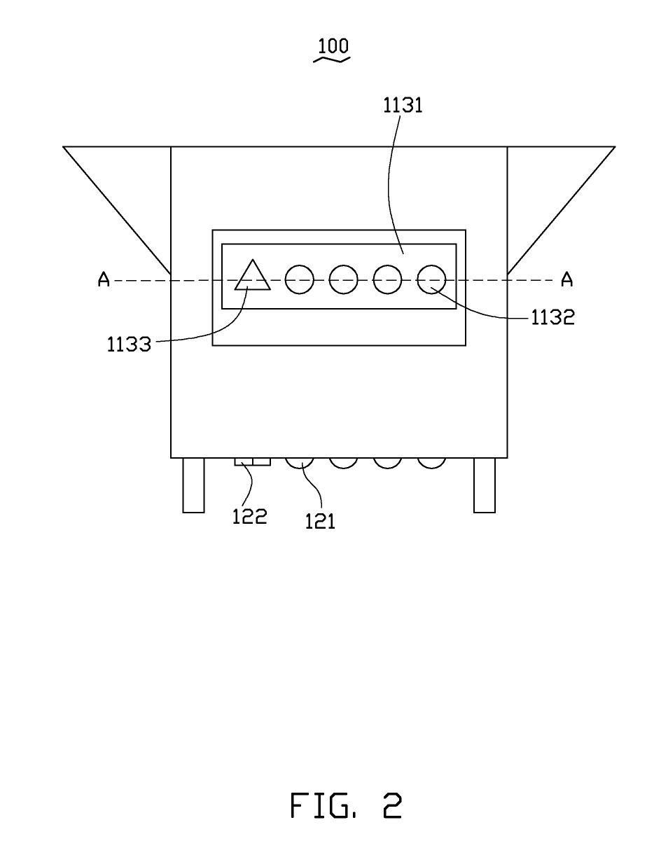

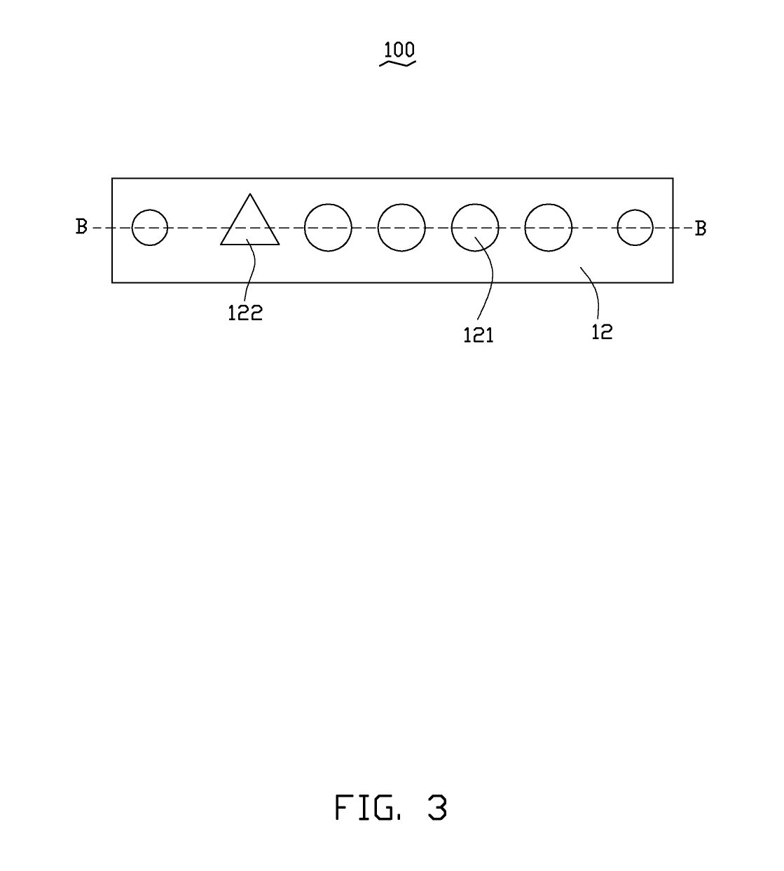

FIGS. 1-3 show a lens element 100, according to an embodiment.

The lens element 100 can be made of transparent plastic by injection molding.

The lens element 100 is substantially rectangular and includes a first surface 11 and a second surface 12 substantially perpendicularly connected to the first surface 11. The lens element 100 defines a substantially rectangular recess 111 in a central part of the first surface 11. The lens element 100 also includes a substantially rectangular platform 113 extending up from a bottom surface 112 of the recess 111.

The platform 113 includes a third surface 1131. The first surface 11, the bottom surface 112, and the third surface 1131 are substantially parallel to each other, and long sides of the lens element 100, the recess 112, and the platform 1131 are substantially parallel to each other.

The lens element 100 also includes a number of internal lenses 1132 extending up from the third surface 1131 and a first mark 1133 formed on the third surface 1131. The internal lenses 1132 are substantially identical to each other but are different from the first mark in shape and size. The internal lenses 1132 and the first mark 1133 are linearly arranged along a first line AA, with the first mark 1133 located at an end of the internal lenses 1132.

The lens element 100 also includes a number of external lenses 121 extending out from the second surface 12 and a second mark 122 formed on the second surface 12. The external lenses 121 are substantially identical to each other but are different from the second mark 122 in shape and size. The external lenses 121 and the second mark 122 are linearly arranged along a second line BB, with the second mark 122 located at an end of the external lenses 121.

The internal lenses 1132 and the external lenses 121 are convex lenses. In this embodiment, a number of the internal lenses 1131 and the external lenses 121 is four, but the number is not limited to four. The external lenses 121 are optically coupled with the internal lenses 1132.

The first mark 1133 and the second mark 122 are raised blocks shaped as equilateral triangles. In this embodiment, the first line AA and the second line BB pass through centers of the first mark 1133 and the second mark 122, respectively. However, configurations, such as shapes and positions of the first mark 1133 and the second mark 122, are not limited to this embodiment. In alternative embodiments, the first mark 1133 and the second mark 122 can be formed in a recess or take the form of other suitable shapes, such as a cross, for example.

The first mark 1133 and the second mark 122 serve as reference points for inspectors when inspecting the internal lenses 1132 and 121.

In alternative embodiments, only the internal lenses 1132 with the first mark 1133 or the external lenses 121 with the second mark 122 are employed.

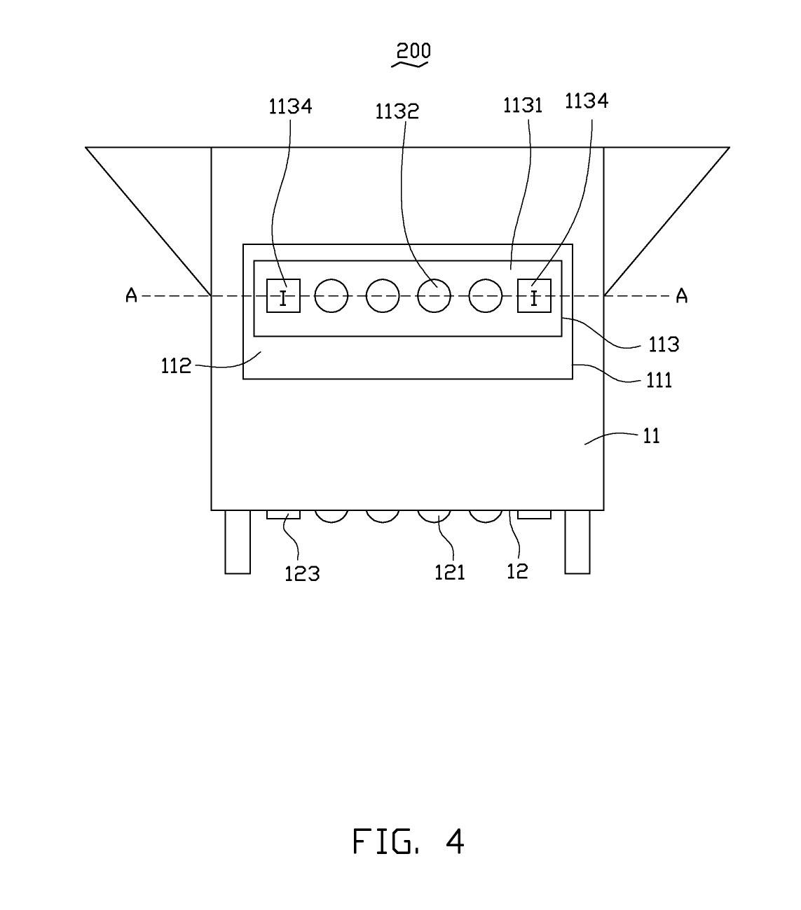

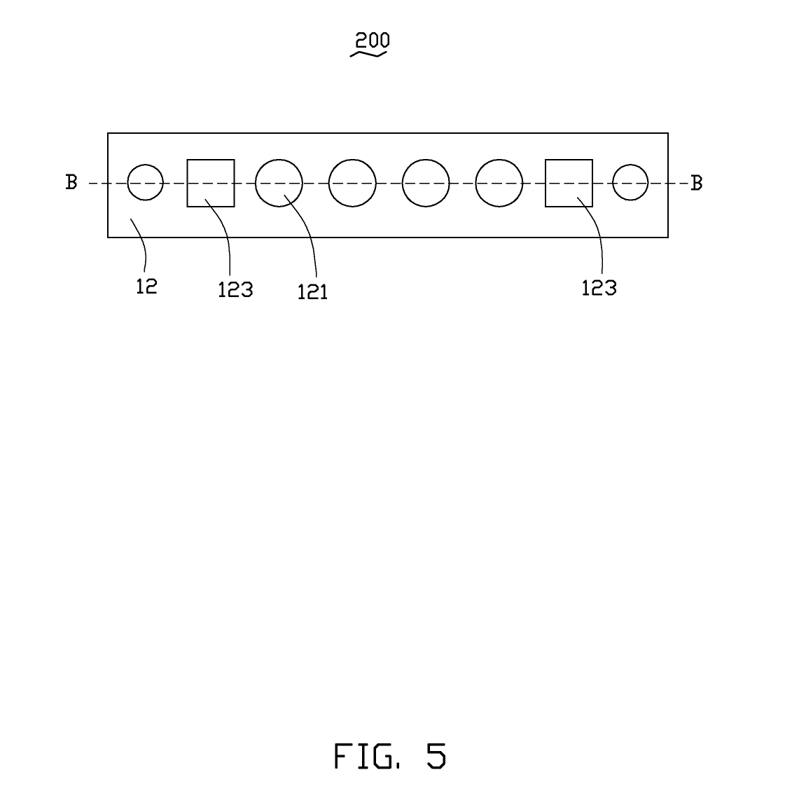

Referring to FIGS. 4-5, a lens element 200, according to another embodiment, is substantially similar to the lens element 100, except that instead of the first mark 1133 and the second mark 122, the lens element 200 includes a pair of third marks 1134 and a pair of fourth marks 123. The third marks 1134 are square blocks and are located at two outermost sides of the internal lenses 1132, and the fourth marks 123 are square blocks and are located at two outermost sides of the external lenses 121. Each of the third marks 1134 and the fourth marks 123 forms a character, such as “1,” on an upper surface of it. The characters on the third marks 1134 are identical in orientation, and the characters on the fourth marks 123 are identical in orientation. As such, the third marks and the fourth marks serve as reference points to assist inspectors in recognizing the internal lenses 1132 and the external lenses 121, respectively.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A lens element comprising:
a plurality of lenses substantially identical with each other in shape and size; and
a mark different from the lenses in shape and size;
wherein the lenses and the mark are linearly arranged and the mark is located at an outermost side of the lenses.

2. The lens element of claim 1, wherein the lens element is substantially rectangular and comprises a first surface and a second surface perpendicular to the first surface, the lens element defines a recess in the first surface and comprises a platform extending up from a bottom surface of the recess, the platform comprises a third surface, and the lenses and the marks are positioned on the second surface or the third surface.

3. The lens element of claim 1, comprising another mark, the marks being located at two opposite outermost sides of the lenses, each mark forming a character on an upper surface thereof, orientations of the characters being identical with each other.
